(19) United States
(12) Patent Application Publication
(10) Pub. No.: US 2012/0060436 A1
(43) Pub. Date: Mar. 15, 2012

(54) BALLISTIC AWNING

(76) Inventor: Charles F. ZIMMER, II, New Orleans, LA (US)

(21) Appl. No.: 13/299,261

(22) Filed: Nov. 17, 2011

Related U.S. Application Data
(63) Continuation-in-part of application No. 29/367,756, filed on Aug. 12, 2010.
(60) Provisional application No. 61/415,004, filed on Nov. 18, 2010.

(51) Int. Cl. E04H 9/00; E06B 3/30

(52) U.S. Cl. 52/202; 52/741.3

(57) ABSTRACT

A method for deploying a security awning that includes repositioning at least one support device for a security awning on a building, wherein the security awning comprises at least one panel, a pivotable mounting, and at least one security interface, and wherein the security awning is at least partially held in place by the at least one support device; pivoting the at least one panel about the pivotable mounting to cover a portion of the building; and coupling the at least one panel to the building by the at least one security interface.

### CROSS-REFERENCE TO RELATED APPLICATIONS

This application claims the benefit under 35 U.S.C. §119(e) of U.S. Provisional Patent Application Ser. No. 61/415,004, filed on Nov. 18, 2010. This application is also a continuation in-part of Design Pat. Application No. 29/367,756, filed Aug. 12, 2010.

### STATEMENT REGARDING FEDERALLY SPONSORED RESEARCH OR DEVELOPMENT

Not Applicable.

### FIELD OF THE INVENTION

This invention relates to securing a building and more specifically to protecting a building against projectiles or intrusion by a repositionable awning apparatus.

### BACKGROUND OF THE INVENTION

There are several storm shutters, roll-down doors, and other various rigid and flexible structural covers designed for building integrity protection. Conventionally, a thin sheet of plywood, aluminum, rigid plastic, or other material is secured to the structure as the extent of protection. More advanced protection includes roll-down doors and stacked or folded accordion-style doors, made of segmented metal or composite panels. These structures are designed to reduce the physical effects of high wind events and minor impacts. However, they have limited effectiveness for the reduction of damage and protection of structural integrity.

As previously noted in U.S. patent application. Ser. No. 12/551,873, incorporated herein by reference in entirety for all purposes, these roll down and folding structures have a high aesthetic cost and a high cost associated with the material, installation, and maintenance. As the panels serve no function for most of their installed lifetime, they are retained in boxed enclosures or covers that appear grafted onto a structure, or folded to the side(s) of an opening in a manner that consumes a material percentage of the opening. Furthermore, these storage enclosures are rarely completely incorporated into the building aesthetics and design, and retro-fit options are limited by the structural strength required to safely hold the load associated with existing designs. As such, there is a need in the industry for a ballistic panel system that is configurable as a building design element, and suitable for retro-fit on a broader population of structures.

### BRIEF SUMMARY

In one configuration according to the disclosure an apparatus for protecting a building comprises, a foldable panel configurable for storage in a first position as an awning. The panels are deployable, and movable into a second position to secure, a building entrance, window, or vulnerability from damage, penetration, and/or vandalism.

Embodiments disclosed herein pertain to an apparatus that may include a panel, having a first end and a second end; a pivot may be pivotably coupled to the first end of the panel and mounted on a building, such that the panel may be configured to pivot from a first position to a second position about the pivot. The first position may be between about, 90 degrees to 1 degrees with respect to the building façade and the second position may be substantially parallel to and in contact with, the façade. There may be at least one support configured to support the panel in the first position, and there may be least one securing mechanism configured to retain the panel when the panel is in the second position.

The panel may be a ballistic panel chosen from the group of materials consisting of metals, alloys, ceramics, polymers, composites, fabrics, and combinations thereof. In one embodiment, the panel in the first position may be an awning, and in another embodiment the panel in the second position may be a hurricane panel. The panel may include a reinforced folding device configured to shorten the length of the panel in the first position and extend the length of the panel in the second position.

The at least one securing mechanism may be configured to reversibly secure the second end of the panel to the building. The securing mechanism may include an electromagnet disposed on the building and a magnetic material disposed on the panel. The at least one support may be configured to couple a portion of the panel distal from the pivot to the building, and may also support a portion of the load of the panel. In an embodiment, the at least one support may, be chosen from the group consisting of trusses, struts, braces, wires, cables, rods and clevises, turnbuckles, and combinations thereof. Accordingly, the at least one support may be configured to facilitates movement of the panel from the first position to a second position. In a particular embodiment, the at least one support may be an actuator.

Other embodiments disclosed herein pertain to a building awning apparatus that may include a first panel with a first end and a second end, wherein the first panel may be pivotably coupled to a building at the first end; a second panel with a first panel end and a second panel end, wherein the second panel may be pivotably coupled to the first panel second end by a hinge, and wherein the second panel may be configured to move about the hinge to form a single plane with the first panel. There may be at least one panel support having a first support end coupled to the building and a second support end coupled to at least one of the first panel or the second panel and configured for removably retaining the first or second panel at an angle with respect the building; and at least one security interface.

In embodiments, the hinge may be an extension coupled to the second end of the first panel and the first end of the second panel. In this aspect, the hinge may be configured as an interface between the first panel second end and the second panel first end, and extending along at least one surface of each panel. The extension may be configured to protect the hinge, the first panel, and at least one second panel from damage.

The building awning apparatus may also include a panel cover, such that the panel cover may protect the panel and may also provide an aesthetic exterior for the panel to incorporate the panel into the building appearance as an awning. The at least one panel support may be chosen from the group consisting of trusses, struts, braces, wires, cables, rods and devises, turnbuckles, and combinations thereof. The at least one panel support may include an actuator configured to move the first panel from a first position to a second position, wherein the first position may be between about 90 degrees to 1 degrees with respect to the building façade and the second position may be substantially parallel to and contacting the building. The apparatus may also include at least one security interface that may be a device usable to reversibly retain and selectively secure the first panel against the building.

Yet other embodiments disclosed herein are directed to a method for deploying a security awning that may include the steps of repositioning at least one support device for a security awning on a building, such that the security awning may have at least one panel, a pivotable mounting, and at least one security interface. In some aspects, the security awning may be at least partially held in place by the at least one support device.

Other steps of the method may include pivoting the at least one panel about the pivotable mounting to cover a portion of the building; and coupling the at least one panel to the building by the at least one security interface. The method may also include operating an actuator to pivot the at least one panel to cover a portion of the building, wherein the actuator is configured to be the at least one support device; and coupling the at least one security interface to the building reversibly, wherein the at least one security interface comprise electromagnets integral to the building and the panel.

These and other configurations, features, and advantages of the disclosure will be apparent with reference to the following drawings and description.

### BRIEF DESCRIPTION OF THE DRAWINGS

FIG. 1 illustrates a low elevation three-quarter view of a ballistic awning according to one embodiment of the disclosure.

FIG. 2 illustrates a side view of a ballistic awning according to one embodiment of the disclosure.

FIG. 3 illustrates a side view of a ballistic awning according to another embodiment of the disclosure.

FIG. 4 illustrates a high elevation three-quarter view of a ballistic awning according to one embodiment of the disclosure.

FIG. 5 illustrates a detail view of a hinge of a ballistic awning according to one embodiment of the disclosure.

FIG. 6 illustrates a front view of a ballistic awning according to one embodiment of the disclosure.

FIG. 7 illustrates a front view of a ballistic awning system according to one embodiment of the disclosure.

FIG. 8 illustrates a high elevation view of a ballistic awning system according to one embodiment of the disclosure.

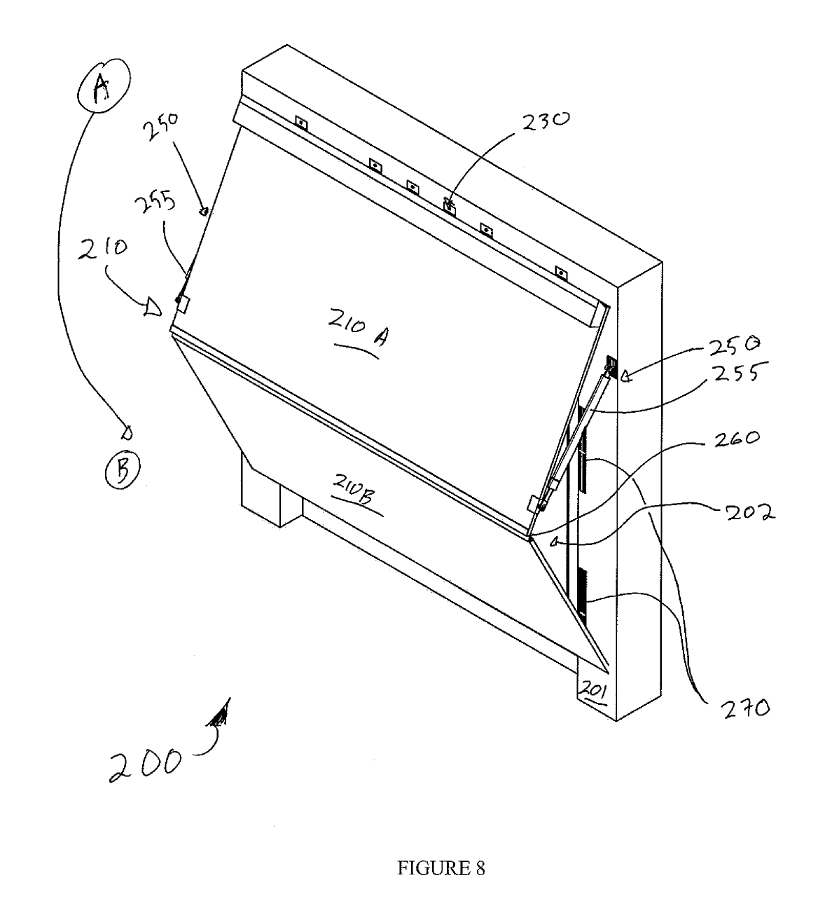

FIG. 9 illustrates a profile view of a ballistic awning system with two actuators according to one embodiment of the disclosure.

FIG. 10 illustrates a three quarter elevation view of a ballistic awning system with two actuators according to one embodiment of the disclosure.

### DETAILED DESCRIPTION

Overview: In embodiments, the present disclosure relates to a deployable wind, weather, projectile, hurricane, as used hereinafter “hurricane,” and general security protection device that is stowable as an architectural or aesthetic feature of a building or other structure. In certain configurations, the hurricane protection device is configured as an overhang, a shade, a covering, an awning, or any other secondary covering or other structure mounted to the exterior of a building or other structure. Further in some configurations, the hurricane protection device is configured to deploy over a window; door, or any opening in a building, a building facade, or other support structure. The present device comprises one or more panels, a coupling, and a support. The panel may be articulated such that the area of the panel in the stowed position is less than about half the panel when it is in the deployed position. The coupling and support retain the panel on the façade, wall, or face of a building or other support structure. In certain instances, the support is repositionable or removable from the building, manually or by a mechanical device. In further configurations, the panel may be reversibly coupled to a building or other structure in the deployed position. In non-limiting examples, coupling may occur with mechanical devices such as latches, by magnetic means, such as magnets or electromagnets, and so forth. In certain instances, the panel disclosed herein may be a AWNING-STOWABLE PANEL design, as, disclosed in US Design Pat. Application No. 29/367,756, incorporated herein by reference for all purposes.

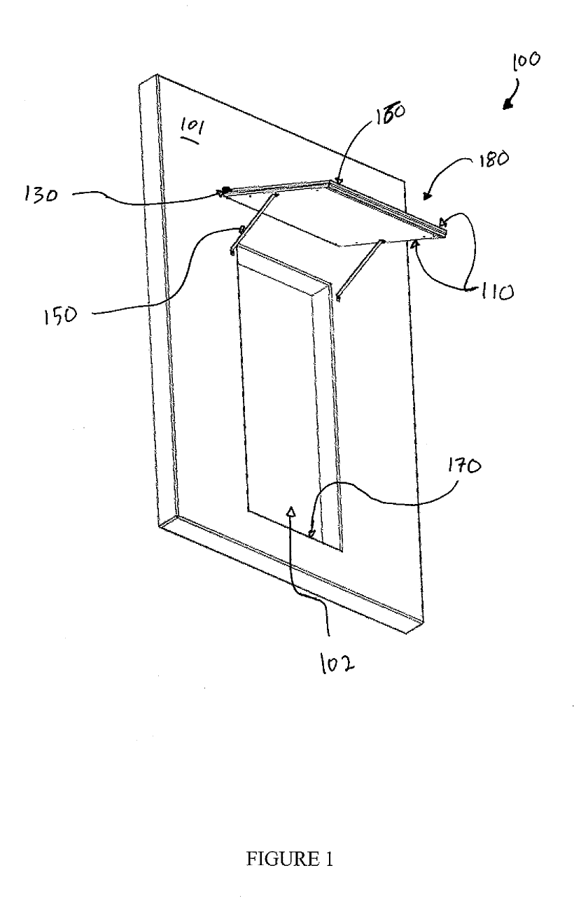

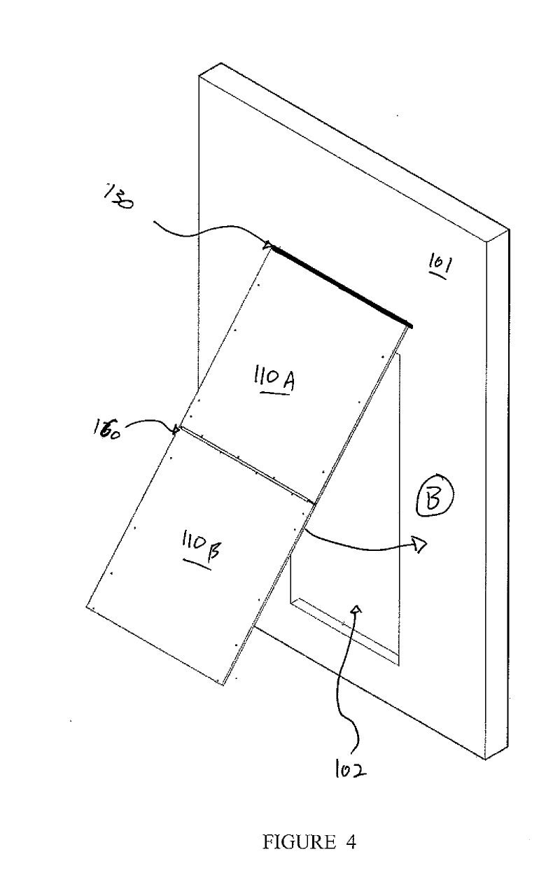

The FIGS. 1 through 6 illustrate a panel system 100 configured for securing a building 101, openings 102 of a building 101, doors, or windows of a building, or other means of entering any structure. The panel system 100 is configurable as an awning when not in being utilized to securing a building or structure. When deployed, the panel system covers the building 101 and/or the openings 102 therein. In embodiments, the panel system comprises a panel 110, a mounting hinge 130, awning support 150, hinge 160, and a security interface 170. Panel system 100 comprises aesthetic cover 180. Further, supports 150 may comprise aesthetic features in certain configurations.

FIGS. 1, 4 and 6 view sequentially further illustrate a nonlimiting exemplary sequence of steps to deploy the panel system 100 from the stowed position A to the deployed position B. In embodiments, the panel 110 is deployed by removing from the awning support 150, and pivoting panel 110 downward to cover the opening 102. In certain instances, the panel 110 comprises a plurality of panels, 110A and 110B coupled by a hinge 160. In instances, hinge 160 allows folded configuration in stowed position A and unfolded configuration in deployed position B. In further instances, the awning support 150 is removed from the building 101 alternatively, awning support 150 is relocated or moved to facilitate panel 110 deployment. In certain configurations, awning support 150 is a device 155 operable deploy panel(s) 110 mechanically, and in further configurations, awning support 150 is a device 155 operable to deploy and stow or retract panel 110.

Panel. Panel 110 is configured as a low or reduced weight panel that may easily be lifted and supported in a horizontal, approximately horizontal, or sloped orientation from a building 101. Panel 110 is configured for deployment to cover openings 102 in the building 101. Panel 110 comprises a generally rigid, planar sheet of material. Alternatively, panel 110 comprises a composite panel, comprising a plurality of materials or structures combined to form a unitary or monolithic structure. In certain instances, panel 110 comprises any alternate construction and configuration that retains the ability to cover an opening 102 and provide ballistic protection. Alternate configurations include the nonlimiting examples ballistic textiles, hollow panels, corrugated panels, layered panels, polycarbonate, plastic, filled panels, honeycomb panels, and combinations or modifications thereof In embodiments panel 110 is configured to exceed the dimensions of the openings 102 of a building 101. Without wishing to be limited by theory, the panel 110 extends beyond the dimensions of any openings 102 of a building 101, such that wind, water, debris, shrapnel, and other projectiles cannot directly impact the opening 102. Further, the panel 110 is configured to prevent ricocheted, deflected, or redirected projectiles from entering interior of building 101 through the aforementioned openings 102.

In embodiments, the panel 110 comprises at least one, generally planar, sheet of any material(s) suitable for withstanding projectile impacts, water, and wind. Panel 110 comprises materials such as but not limited to metals, alloys, ceramics, polymers, composites, fabrics, or combinations thereof. Panel 110 comprises a metal or metal alloy, such as, but not limited to, steel, aluminum, magnesium, manganese, chromium, titanium, vanadium, or tungsten. In instances, panel 110 comprises other metals or metallic structures understood to be impact resistant. In non-limiting instances, panel 110 comprises corrugated, honeycomb, boxed, tubed, swaged, beaded, or pressed metals. Alternatively, panel 110 comprises a ceramic such as, but not limited to, alumina, aluminum oxide, boron carbide, and silicon carbide. Panel 110 comprises a polymer, polymer fiber, polymer panel, and combinations thereof. In instances, the panel 110 comprises a polymer such as polyethylene, polystyrene, polypropylene, polyurethane or other polymer resins, poly-acrylamide, para-amids, polybenzoxaole, and the like, without limitation. In polymer or resin configurations, panel 110 may comprise a filler or base material, such as but not limited to saw-dust, paper, pulp, cotton, linen, fiberglass, carbon fiber, carbon black, and other fibrous fillers known in the art.

In embodiments, the panel 110 comprises a reinforcement material, for instance a fabric, film, screen, or honeycomb. In further embodiments, panel 110 comprises a plurality of layers, wherein at least one layer comprises reinforcement layer adhered to at least one layer. In certain instances, the reinforcement layer comprises ballistic fabrics or weaves including, but not limited to, KEVLAR®, aramid, SPECTRA®, TWARON®, ZYLON®, as well as non-fabric materials including, but not limited to, carbon fiber, nanotubes, metal, metal wire mesh, polymer films, resins, or the like, without limitation. In certain instances; the reinforcement is cast, molded, or otherwise impregnated into the matrix of panel 110. Alternatively, the reinforcement is bonded, adhered, or welded to other materials in panel 110. In certain instances, comprises a reinforcing coating applied to at least one exterior face. The reinforcement layer is configured to provide impact dissipation, shear strength, flexibility, and combinations thereof to the panel 110. Without limitation by theory, the reinforcement material maintains the integrity of the panel 110 after impact. Further, the reinforcement material prevents fragmentation, shear fracture, brittle fracture, or other failure modes of the panel 110 after impact of a projectile or a plurality of projectiles. In certain instances, reinforcement material in panel 110 prevents portions of panel 110 from becoming additional debris, projectiles, or shrapnel.

In certain embodiments, panel 110 is configured to facilitate attachment, coupling, connection, fastening, and/or securing the panel 110 over the opening 102. In instances, the panel 110 may comprises components, devices, material, or modifications approximate to the outer dimensions or perimeter of panel 110 to facilitate securing the panel 110 over opening 102. In certain instances, the panel 110 is configured to facilitate securing beyond the perimeter of the opening 102 to the building.

Cover. In certain embodiments, panel 110 comprises cover. In instances, cover is a fabric, polymer, or metallic covering for panel 110. Without limitation by theory, cover provides an exterior design option to blend the panel with the aesthetics of a building façade, improve panel resistance to weather, improve panel resistance to projectiles, or combinations thereof. In instances, the cover may be water, wind, sun, UV, ozone, pollution, and excrement resistant, such that the panel 110 is not directly or excessively exposed to daily weather conditions. Additionally, cover 110 may protect panel from human vandalism or animal-derived damage. In further instances, the cover may be resistant to fungus, mold, mildew; moss, and other microorganisms known to grow on buildings. In further alternate embodiments, the cover is integral to any component of the panel 110.

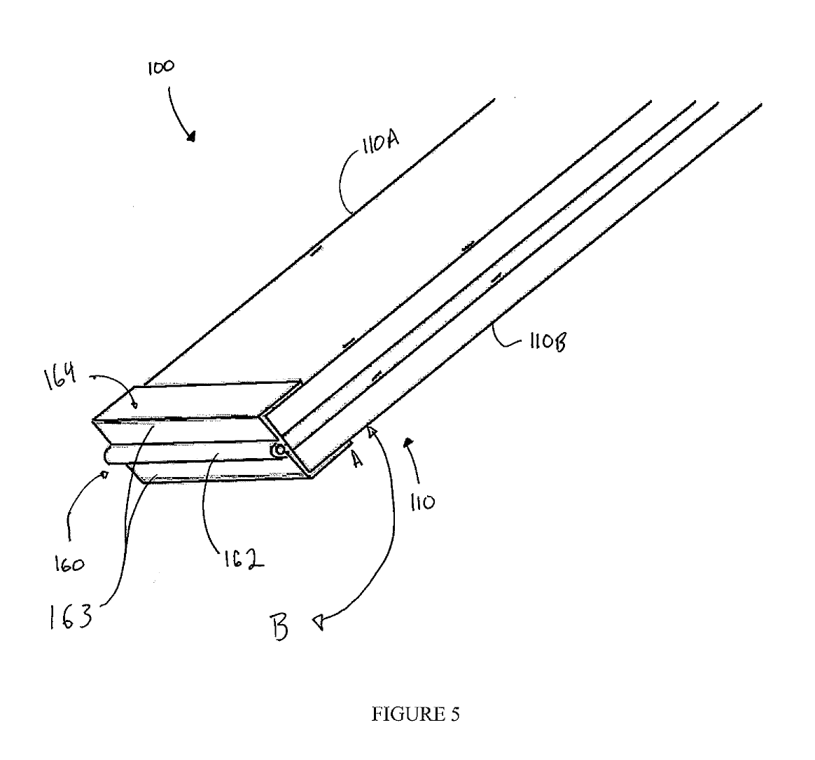

Hinge. Referring now to FIG. 5, the panel system 100 comprises a hinge 160 disposed between at least two adjacent panels 110. Hinge 160 may be disposed between at least two adjacent panels of the same size. Alternatively, hinge 160 may be disposed between at least two adjacent panels of different sizes. In suitable for withstanding projectile impacts embodiments, hinge 160 is constructed of any material and high pressures; alternatively, for withstanding explosions, shrapnel, and explosive shockwaves.

In embodiments, Hinge 160 comprises a metal hinge. Alternatively, hinge is any material suitable for pivoting, rotating, of bending action. In certain instances, hinge 160 is formed to prevent damage or stress that inhibits the action of hinge. Alternate hinge 160 materials include without limitation, ballistic cloth, polymers, and any material configured for impact resistance. In certain instances, hinge 160 includes processing or treatment such as TEFLON® (PTFE) impregnation, metallic alloy coating, or metallic plating without limitation, to improve or maintain operation after deformation or damage. In instances, the panel system 100 comprises a first panel 110A pivotably coupled a second panel 110B by any pivotable connection or hinge 160.

In embodiments, hinge 160 comprises a pivot 162, leaf 163 and leaf extension 164. Pivot 162 comprises the axis of rotation for panel 110B to move from the stowed position. A to the deployed position B. In embodiments, hinge 160 is configured to rotate about pivot 162 such that first panel 110A and second panel 110B are substantially flat or touching when in the stowed position A. Further, in the stowed position A, the hinge 160 is pivoted such that the panels 110A and 110B may be positioned parallel, adjacent or in contact along one face.

In embodiments, leaf extension 164 comprises an extension of a leaf 163 along the surface of a panel 110. As understood by a skilled artisan, a leaf 163 comprises a portion of the hinge 160 extending away from the pivot 162. In embodiments, the leaf extension 164 extends further from pivot 162 and leaf 163 to provide protection for hinge 160 and panel 110 from damage. Without limitation by theory, the leaf extension 162 and leaf 163 provide protection for the distal end of the panel system 100 when in the stowed position A. Additionally, the leaf extension 164 provides impact, crush, wear, and bend resistance along hinge 160 and maintaining connection between first panel 110A and second panel 110B. In certain instances, leaf extension 164 stabilizes first panel 110A and second panel 110B in both the stowed position A and the extended position B.

Mounting. Referring to FIGS. 1 to 4, system 100 comprises a pivotable means to couple panel 110 to the building 101, such as mounting hinge 130. In embodiments, mounting hinge 130 comprises any material suitable for pivoting, rotating, or bending action, such as the nonlimiting examples, ballistic cloth, flexible polymers, and any flexible material configured for impact resistance. Alternatively, mounting hinge 130 comprises any pivotable structure, including hinges, rods, bushings, bearings, pivot bars, ball and socket joints with panel 110. In certain instances, mounting hinge 130 comprises a plurality of components configured for pivotably coupling panel 110 to the building 101.

In embodiments, mounting hinge 130 is configured to at least partially support the vertically hanging weight of the panel system 100 vertically adjacent to the opening 102 of the building 101. In certain instances, the vertically hanging weight of the panel system 100 may be at least partially supported by other components of the panel system 100. The mounting hinge is coupled or attached to the building 101 by any means known to one skilled in the art, including anchors, threaded fasteners, nails, posts and pins, clamps, drive anchors, devises, and expansion couplers, without limitation. In certain instances, the mounting hinge 130 may support the vertically hanging weight of the panel system 100 from any structure of a building. Non-limiting examples include walls, ceilings, overhangs, ledges, planters, and balconies.

In embodiments, mounting hinge 130 is configured to be weather resistant. Further, mounting hinge 130 is configured for continued operation after deformation or damage. In instances, mounting hinge 130 is hardened or treated to increase impact resistance. In certain instances, mounting hinge 130 includes processing or treatment such as TEFLON® (PTFE) impregnation, metallic alloy coating, or metallic plating without limitation, to improve or maintain operation after deformation or damage.

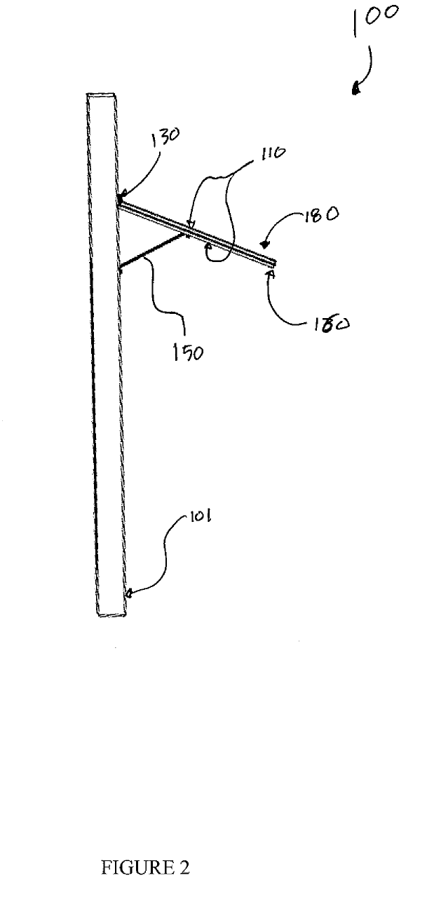

Support. Referring to FIGS. 1, and 2, panel system comprises an awning support 150. In embodiments, awning support 150 comprises any structure or device extending from building 101 to the panel 110. In certain instances, the awning support 150 at least partially supports the panel 110 in the stowed position A. Awning support 150 may attach to building 101 below the panel 110. In instances, awning support 150 is a generally rigid support member, such as but not limited to a truss, a strut, or a brace, configured for support a load in compression or from below. Alternatively, the awning support may attach to building 101 above the panel 110. In instances, awning support member 150 is configured support the panel 110 in tension or from above. In non-limiting examples, the awning support 150 may be a wire, a cable, a rod and clevis, or a turnbuckle.

In embodiments, awning support 150 is configured to hold panel 110 away from building 101 in the stowed position A. Awning support 150 may hold panel 110 at any angle with respect to building 101. In non-limiting examples, the awning support 150 is configured to hold panel 110 angled parallel with the ground or angled downwards toward the ground. Without limitation by theory, this configuration provides shelter from the weather for the building 101 and opening 102 below the panel 110. Additionally, a downward slope to, panel 110 allows for run off of precipitation. Without limitation by theory, a downward slope to panel 110 provides shelter for pedestrians, bicycles, and other light vehicles below the panel 110. In further embodiments, the awning support 150 may retain the panel 110 angled away from the ground. In upward angled configurations, the panel 110 may comprise a decorative or aesthetic feature. Further, in upward angled configurations, the panel 110 may be removed from interfering with a covered walkway, for example in an outdoor shopping center or strip mall. In further non-limiting examples, the panel 110 may be retained by the support member 150 in an upward slope to avoid vandalism or damage from traffic.

In embodiments, awning support 150 is movably coupled to the building 101. In instances, awning support 150 is coupled to building my any means or coupler known to one skilled in the art. Non-limiting exemplary awning support 150 couplers include, threaded fasteners, nails, posts and pins, clamps, drive anchors, clevises, and expansion couplers. Awning support 150 is configured to move with panel 110 or out of the path of panel 110 during deployment. In certain instances, awning support 150 is removable from building. Without limitation by theory, removing awning support 150 from building 101 reduces costs of replacing damaged supports. Further, removal of the awning support 150 from building 101 reduces the risk of the component becoming a projectile to impact the panel system 100. In instances, a threaded coupler such as a screw or bolt, and alternatively, locking pins or expansion pins may be used to removably couple awning support 150 to the building 101.

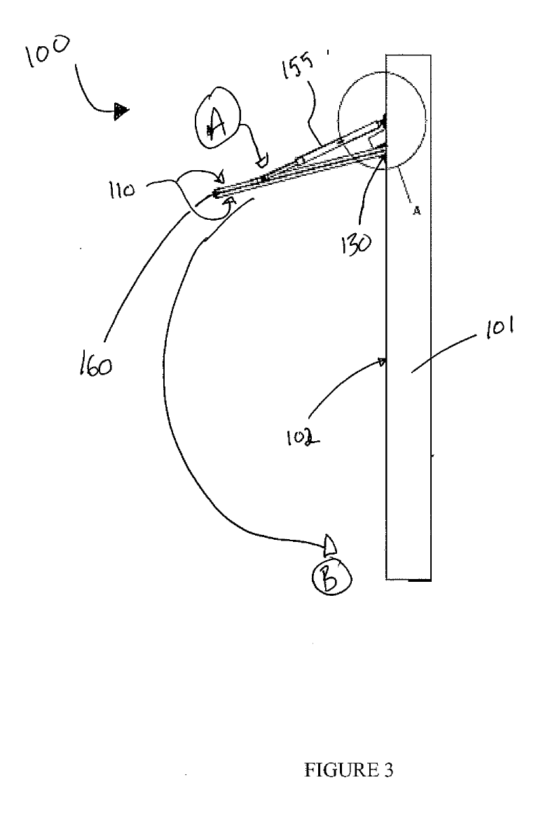

In certain embodiments, the awning support 150 is an actuator. Referring now to FIG. 3, actuator 155 comprises any device configurable or operable to deploy panel 110 from stowed position A to deployed position B. In non limiting examples, actuator 155 may be a linear device configured for extending and retracting, such as a piston. Alternatively, the actuator 155 comprises a rotatable device and flexible connection, such as a gear and chain or a cable and spool. In instances, the actuator 155 maybe electrical, pneumatic, hydraulic, or combinations thereof. In further instances, actuator 155 may be configurable and operable to perform complex actions, in a non-limiting example, unfolding a panel 110 and rotating it into place over opening 102. In further instances, the actuator 155 may comprise a plurality of device operating in different manners to deploy panel 110.

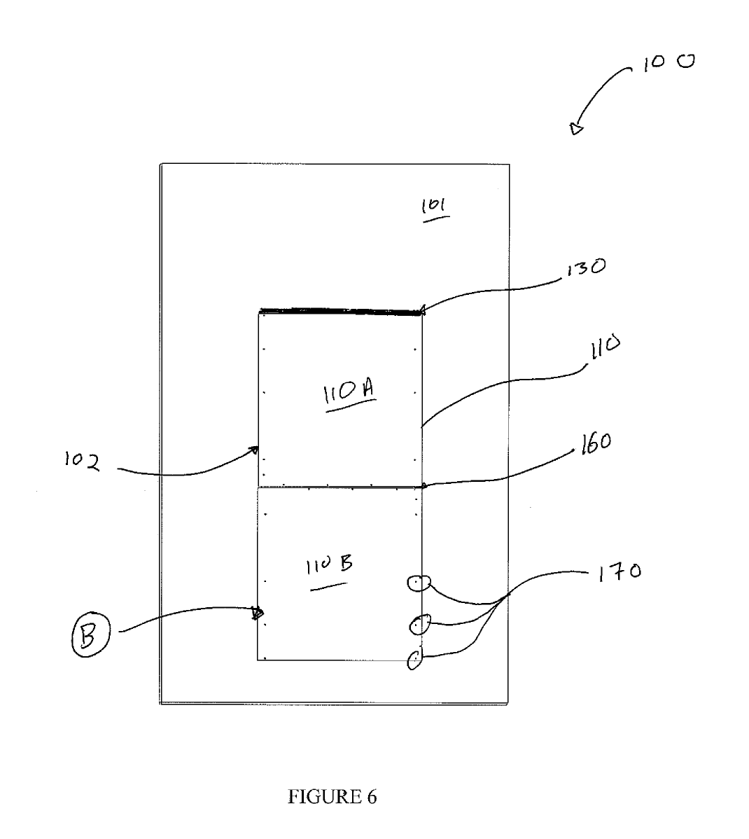

Securing. Referring now to FIG. 6, in the deployed position B, the panel 110 covers the opening 102. In instances, the panel 110 is secured to building 101 by a security interface 170. Security interface 170 is any means configured to retain the panel 110 in the deployed position B against the building 101. In further instances, security interface 170 comprises devices, materials, or modifications approximate to the outer dimensions or perimeter of panel 110 to facilitate securing the panel 110 over opening 102. In certain instances, security interface 170 comprises at least one coupler, such as but not limited to threaded fasteners, nails, posts and pins, clamps, drive anchors, clevises, and expansion couplers. Alternatively, security interface 170 comprises at least one slidable interface, such as a sliding pin and receiver wherein a receiver is a latch or loop. In further instances, security interface 170 comprises a cylinder lock, a padlock, a latch lock, or any other locking means without limitation. As may be understood by a skilled artisan, it may be desirable to lock security interface 170 against the building 101 such that vandals, looters, and animals may not gain access through the opening 102.

In certain embodiments, the security interface 170 comprises a magnetic or electromagnetic lock. In instances, the building 101 or opening 102 has electromagnets disposed about the perimeter of the opening. In certain instances, the panel 110 comprises strong magnets, such as rare earth magnets, positioned within the panel 110 that coincide with the location of the building 101 electromagnets. As may be understood by one skilled in the art, weather and other events may result in the loss of electricity supply to the building 101. As such, in this configuration the uncharged state of the electromagnet is the locked state. Charging, or applying a charge or current to the electromagnet unlocks a security interface 170 configured in this manner.

### EXAMPLES

### Example 1

In a non-limiting exemplary configuration, the panel comprises an all metal construction. In this embodiment, the panel comprises an, aluminum skin disposed on top of an aluminum honeycomb, and reinforced by an aluminum sheet. The skin, honeycomb, and reinforcing sheet are bonded together to form the panel.

The aluminum skin is configured for exposure to sun, storms, or hurricanes. The skin may comprise an alloy of aluminum, such as but not limited to 2000 series to 9000 series alloys. The aluminum skin comprises a thickness between about 0.01 inch and about 0.08 inches; alternatively the aluminum skin is between about 0.02 inches and about 0.06 inches; and in further configurations, the aluminum skin is about 0.05 inches thick. Without limitations by theory, in applications with increased exposure to projectiles, the aluminum skin may be thicker. In instances, the aluminum skin is coated by at least one coating. In a nonlimiting example, the skin is coated with a UV resistant coating. In further instances, the aluminum skin is coated with a water resistant coating.

The aluminum honeycomb is configured as a sheet. Without limitation by theory, the aluminum honeycomb comprises a generally planar sheet with a plurality of passages oriented perpendicular to the plane of the sheet. The plurality of passages may have any geometric shape, including but not limited to circular, quadrilateral, or hexagonal. In certain configurations the sheet is between about 0.25 inches and about 1.25 inches; alternatively, the sheet is between about 0.4 inches and about 0.9 inches thick; and alternatively, between about 0.7 inches and about 0.9 inches thick. The walls between the plurality of passages comprise a thickness from between about 0.0001 inches and about 0.5 inches thick; alternatively between about 0.001 inches and about 0.1 inches thick; and alternatively between about 0.001 inches and about 0.01 inches thick. The diameter of the passages is between about 0.001 inches and about 2 inches; alternatively, between about 0.1 inches and about 1.5 inches; and alternatively, between about 0.1 inches and about 0.8 inches.

The reinforcing layer is configured as a sheet. The reinforcing layer may comprise an alloy of aluminum, such as but not limited to 2000 series to 9000 series alloys. The aluminum reinforcing layer comprises a thickness between about 0.001 inch and about 0.08 inches; alternatively the aluminum reinforcing layer is between about 0.002 inches and about 0.06 inches; and in further configurations, the aluminum reinforcing layer is about 0.03 inches thick. Without limitations by theory, in applications with increased exposure to projectiles, the aluminum reinforcing layer may be, thicker. In instances, the aluminum reinforcing layer is coated by at least one coating. In a non-limiting example, the reinforcing layer is coated with a UV resistant coating. In further instances, the aluminum reinforcing layer is coated with a water resistant coating. In still further instances, the aluminum reinforcing layer is coated with a polymer, a composite, or ballistic fabric including, but not limited to, KEVLAR®, aramid, SPECTRA®, TWARON®, ZYLON®, as well as non-fabric materials or composites materials including, but not limited to, carbon fiber, nanotubes, other metals, metal wire mesh, polymer films, resins, or the like, without limitation. As may be understood by a skilled artisan, coating the aluminum reinforcing layer with a polymer may prevent fracture or tearing of the metal sheet. As the last layer in the panel, it is important to maintain the reinforcing layer integrity to prevent impact with the building.

Exemplary Data: In certain instances, the aluminum layered panel described hereinabove may be subjected to integrity testing. Integrity testing includes static load tests, cyclic load tests, and impact resistance tests. Without limitation by theory, the static load tests determine the strength of the panel when exposed to a constant pressure or load. In instances, the static load test simulates debris applying a pressure to the panel. In certain instances, the static load test simulates prolonged exposure to increased or reduced pressures resulting from weather conditions. A cyclic load test simulates rapidly changing conditions, for example caused by buffeting and high wind weather conditions. Table 8.1 illustrates an exemplary positive static load test result and Table 8.2 illustrates an exemplary negative static load test result:

TABLE 8.1
Positive Uniform Static Load Test Results

| Specimen | Gage | Load | Deflection (in.) | | Permanent Set (in.) | | Percent Recovery (%) | |
|---|---|---|---|---|---|---|---|---|
| # | Location | (psf) | Measured | Allowed | Measured | Allowed | Measured | Allowed |
| 1 | C | +45.00 | 1.322 | 2.000 | 0.120 | N/A | 90.96 | 90.00 |
| | | +60.00 | 2.000 | 2.000 | 0.115 | N/A | 94.28 | 90.00 |
| | | +90.00 | 2.698 | N/A | 0.228 | N/A | 91.55 | 80.00 |

TABLE 8.2
Negative Uniform Static Load Test Results

| Specimen | Gage | Load | Deflection (in.) | | Permanent Set (in.) | | Percent Recovery (%) | |
|---|---|---|---|---|---|---|---|---|
| # | Location | (psf) | Measured | Allowed | Measured | Allowed | Measured | Allowed |
| 1 | C | −56.25 | 1.674 | 3.20 | 0.075 | N/A | 95.50 | 90.00 |
| | | −75.00 | 2.015 | 3.20 | 0.113 | N/A | 94.40 | 90.00 |
| | | −112.50 | 2.698 | N/A | 0.188 | N/A | 93.04 | 80.00 |

The aluminum layer panel described hereinabove may be subjected to a projectile or missile test to simulate impacts. In instances, in order to verify the panel is capable of withstanding multiple, high-velocity impacts a wood missile is impacted against the panel in multiple locations. Without limitation by theory, in a severe weather event, the debris from failed buildings is typically similar in mass to the wooden boards having a cross-section of between about 2 inches by 4 inches, and 2 inches by about 6 inches travelling between about 20 ft/sec and about 100 ft/sec. Table 8.3 shows an exemplary wooden missile impact test result.

TABLE 8.3
Large Missile Impact Test Results

| | | | Missile | Missile | Instantaneous | Permanent | X | Y |
|---|---|---|---|---|---|---|---|---|
| Specimen | Impact | Missile | Length | Velocity | Deflection | Deflection | Coord.¹ | Coord.² |
| # | # | Weight | (in.) | (ft/sec.) | (in.) | (in.) | (in.) | (in.) |
| 2 | 1 | 9 lbs | 92 | 50.81 | 0.750 | 0.375 | 47.500 | 27.000 |
| | 2 | 3 oz | | 49.71 | 1.250 | 0.250 | 83.500 | 13.000 |
| | 3 | | | 50.66 | 1.000 | 0.250 | 14.750 | 60.000 |
| | 4 | | | 49.33 | 1.000 | 0.625 | 48.250 | 60.000 |
| | 5 | | | 49.60 | 1.125 | 0.125 | 48.875 | 48.500 |
| 3 | 1 | 9 lbs | 92 | 49.68 | 1.125 | 0.750 | 47.500 | 24.000 |
| | 2 | 3 oz | | 50.38 | 1.250 | 0.123 | 11.500 | 46.000 |
| | 3 | | | 50.43 | 1.000 | 0.063 | 48.375 | 48.000 |
| 4 | 1 | 9 lbs | 92 | 50.49 | 0.630 | 0.125 | 82.000 | 81.000 |
| | 2 | 3 oz | | 50.91 | 1.125 | 0.375 | 51.000 | 68.000 |
| | 3 | | | 58.87 | 0.063 | 0.000 | 48.000 | 48.000 |

¹Measured from the left of test specimen.
²Measured from the bottom of test specimen.

### Example 2

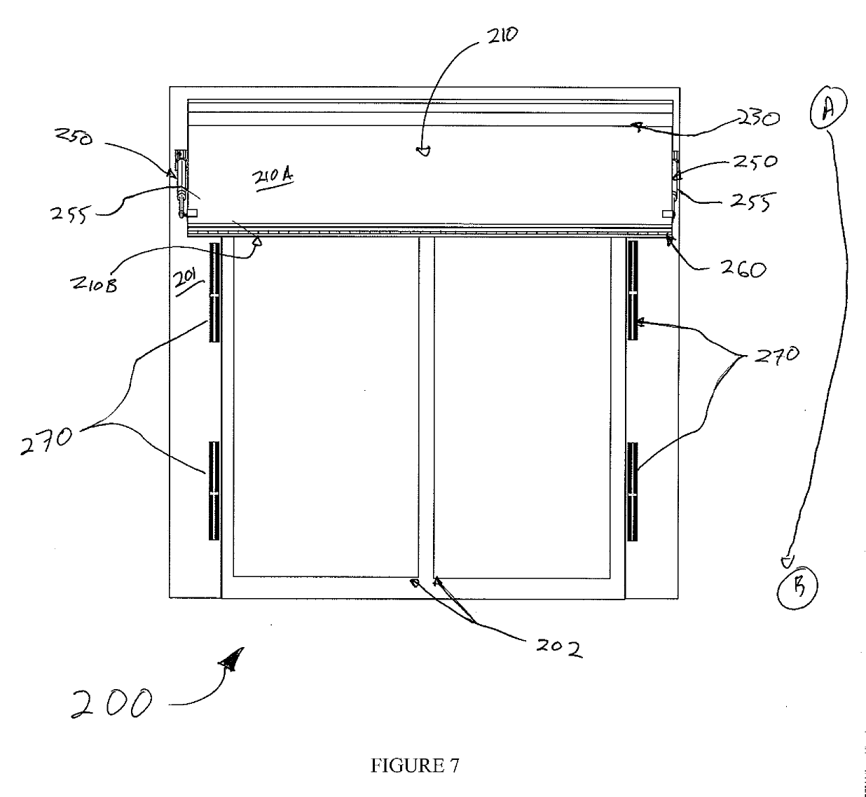

### Referring now to FIG. 7 and, illustrating another non-limiting exemplary configuration of the panel system 200 in a stowed position A and in a partially deployed position B. In embodiments of the present example, the panel system 200 comprises a panel 210 configured to cover a portion window, door, or other opening 202 in the building 201. The panel 210 may comprise any material described hereinabove. In certain instances, the panel 210 comprises two portions of the aluminum skin, honeycomb, and reinforcing sheet bonded together as described in Example 1. In instances the panels are pivotably coupled together by the hinge 260 and to the building by a mounting hinge 230.

In the present non-limiting example, the panel 210 is supported by at least one awning support 250. In certain instances, the awning support 250 comprises an actuator 255. In certain instances, the actuator 255 may be a plurality of actuators 255. The actuator(s) 255 may be configured to deploy panel system 200 from position A to position B. Additionally, the actuators 255 may be configured to lock or otherwise prevent the panel 210 from changing angle or directional orientation with respect to the building 101.

In this exemplary embodiment, security interface 270 comprises at least one electromagnet disposed in or on the building 201 proximal to opening 202. In instances, security interface 270 is an electromagnet disposed on some or all sides of opening(s) 202. In certain instances, the building comprises a plurality of electromagnet security interfaces 270 disposed on each side of the opening(s) 202 and at the base or foot of opening. Without limitation by theory, the plurality of security interface electromagnets 270 may provide an increased level of protection for the building 201 and opening(s) 202 by retaining the panel 210 more firmly.

In this example, the panel 210 comprises a magnet or magnetic material insert (278, not visible) contained within the panel 210 and configured to interact with electromagnet security interface(s) 270. In instances, a magnetic insert 278 is disposed within each panel 210A, 210B. In certain instances, a magnetic insert 278 is disposed at each side of each panel 210A, 210B and configured to coincide with the position of the electromagnet security interfaces 270 positioned on either side of opening 202. Before, during or after the panel(s) are moved to the deployed position B, the electromagnet security interfaces 271 are activated such that the magnetic inserts (278, not visible) are held in place securely against the building 201 and completely cover opening 202.

### Example 3

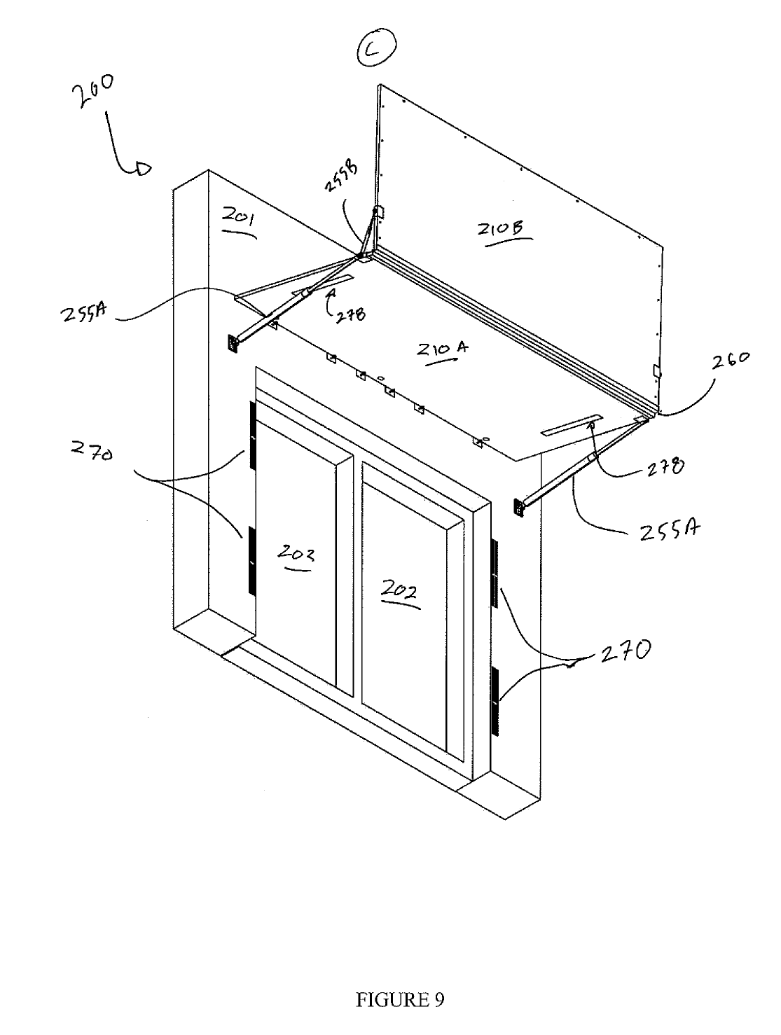

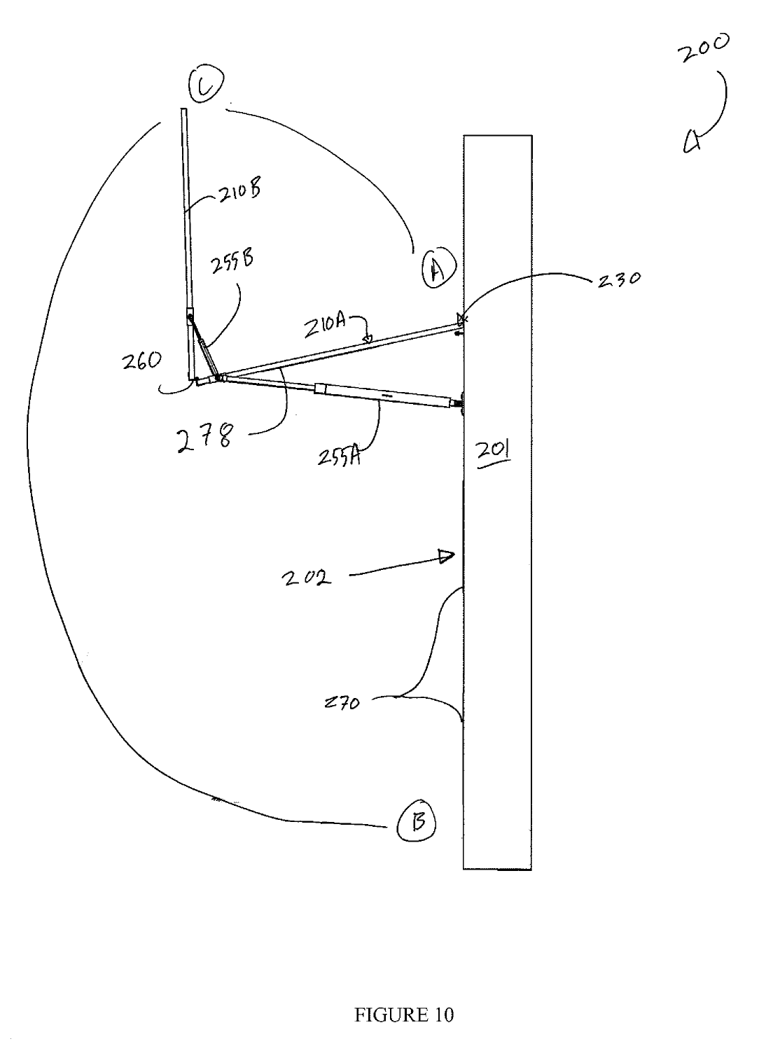

Referring now to FIGS. 9 and 10 and, illustrating another non-limiting exemplary configuration of the panel system 200, having a partially deployed position C, wherein panel 210B rotates away from the structure to store on top of panel 210A. In embodiments of the present example, the panel system 200 comprises a panel 210 configured to cover a portion window, door, or other Opening 202 in the building 201. The panel 210 may comprise any material described hereinabove. In certain instances, the panel 210 comprises two portions of the aluminum skin, honeycomb, and reinforcing sheet bonded together as described in Examples 1 and 2. In instances the panels are pivotably coupled together by the hinge 260 and to the building by a mounting hinge 230.

In the present non-limiting example, the panel 210 is supported by at least one awning support 250. In certain instances, the awning support 250 comprises an actuator 255. In certain instances, the actuator 255 may be a plurality of actuators 255. In the present non-limiting example additional actuators 255B may be configured to deploy panel system 200 from position A to position B, via position C, by rotating panel 210B before or while actuator 255A rotates panel 210A. Additionally, the actuators 255 may be configured to lock or otherwise prevent the panel 210 from changing angle or directional orientation with respect to the building 101.

In this exemplary embodiment, security interface 270 comprises at least one electromagnet disposed in or on the building 201 proximal to opening 202. In instances, security interface 270 is an electromagnet disposed on some or all edges of opening(s) 202. In certain instances, the building comprises a plurality of electromagnet security interfaces 270 disposed on each side of the opening(s) 202. Without limitation by theory, the plurality of security interface electromagnets 270 may provide an increased level of protection for the building 201 and opening(s) 202 by retaining the panel 210 more firmly.

In this example, the panel 210 comprises a magnet or magnetic material insert 278 not visible) contained within the panel 210 and configured to interact with electromagnet security interface(s) 270. In instances, a magnetic insert 278 is disposed within each panel 270A, 270B. In certain instances, a magnetic insert 278 is disposed at multiple points on each panel 210A, 210B and configured to coincide with the position of the electromagnet security interfaces 270. Before, during or after the panel(s) are moved to the deployed position B, the electromagnet security interfaces 271 are activated such that the magnetic inserts 278 are held in place securely against the building 202.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, 50 percent, 51 percent, 52 percent, 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural or other details supplementary to the disclosure.

What is claimed is:

1. An apparatus, comprising,
a panel, having a first end and a second end;
a pivot pivotably coupled to the first end of the panel and mounted on a building, wherein the panel is configured to pivot from a first position to a second position about the pivot, and wherein the first position is between about 90 degrees to 1 degrees with respect to the building façade and the second position is substantially parallel to, and in contact with, the façade;
at least one support configured to support the panel in the first position; and
at least one securing mechanism configured to retain the panel when the panel is in the second position.

2. The apparatus of claim 1, wherein the panel comprises a ballistic panel chosen from the group of materials consisting of metals, alloys, ceramics, polymers, composites, fabrics, and combinations thereof.

3. The apparatus of claim 1 wherein the panel in the first position comprises an awning.

4. The apparatus of claim 1, wherein the panel in the second position comprises a hurricane panel.

5. The apparatus of claim 1, wherein the panel further comprises a reinforced folding, device configured to shorten the length of the panel in the first position and extend the length of the panel in the second position.

6. The apparatus of claim 1, wherein at least one securing mechanism is configured to reversibly secure the second end of the panel to the building.

7. The apparatus of claim 6, wherein the securing mechanism comprises an electromagnet disposed on the building and a magnetic material disposed on the panel.

8. The apparatus of claim 1, wherein the at least one support is configured to couple a portion of the panel distal from the pivot to the building, and to support a portion of the load of the panel.

9. The apparatus of claim 8, wherein the at least one support is chosen from the group consisting of trusses, struts, braces, wires, cables, rods and devises, turnbuckles, and combinations thereof.

10. The apparatus of claim 8, wherein the at least one support is configured to facilitates movement of the panel from the first position to a second position.

11. The apparatus of claim 10, wherein the at least one support comprises an actuator.

12. A building awning apparatus, comprising,
a first panel comprising a first end and a second end, wherein the first panel is pivotably coupled to a building at the first end;
a second panel comprising, a first panel end and a second panel end, wherein the second panel is pivotably coupled to the first panel second end by a hinge, and wherein the second panel is configured to move about the hinge to form a single plane with the first panel;
at least one panel support comprising a first support end coupled to the building and a second support end coupled to at least one of the first panel or the second second panel and configured for removably retaining the first or second panel at an angle with respect the building; and
at least one security interface.

13. The apparatus of claim 12, wherein the hinge comprises an extension coupled to the second end of the first panel and the first end of the second panel, and wherein the hinge is configured as an interface between the first panel second end and the second panel first end, and extending along at least one surface of each panel.

14. The apparatus of claim 13, wherein the extension is configured to protect the hinge, the first panel, and at least one second panel from damage.

15. The apparatus of claim 12, further comprising a panel cover, wherein the panel cover protects the panel and provides an aesthetic exterior for the panel to incorporate the panel into the building appearance as an awning.

16. The apparatus of claim 12, wherein the at least one panel support is chosen from the group consisting of trusses, struts, braces, wires, cables, rods and clevises, turnbuckles, and combinations thereof.

17. The apparatus of claim 16, wherein the at least one panel support comprises an actuator configured to move the first panel from a first position to a second position, wherein the first position is between about 90 degrees to 1 degrees with respect to the building façade, and the second position is substantially parallel to and contacting the building.

18. The apparatus of claim 12, wherein at least one security interface comprises a device to reversibly retain and selectively secure the first panel against the building.

19. A method for deploying a security awning, comprising:
repositioning at least one support device for a security awning on a building, wherein the security awning comprises at least one panel, a pivotable mounting, and at least one security interface, and wherein the security awning is at least partially held in place by the at least one support device;
pivoting the at least one panel about the pivotable mounting to cover a portion of the building; and
coupling the at least one panel to the building by the at least one security interface.

20. The method of claim 19, further comprising:
operating an actuator to pivot the at least one panel to cover a portion of the building, wherein the actuator is configured to be the at least one support device; and
coupling the at least one security interface to the building reversibly, wherein the at least one security interface comprise electromagnets integral to the building and the panel.
